(19) United States
(12) Patent Application Publication
(10) Pub. No.: US 2016/0028870 A1
(43) Pub. Date: Jan. 28, 2016

(54) METHOD OF SHARING INFORMATION OF A MOBILE TERMINAL FOR INTERWORKING BETWEEN AN IN-VEHICLE INFOTAINMENT SYSTEM AND THE MOBILE TERMINAL

(71) Applicant: LG ELECTRONICS INC., Seoul (KR)

(72) Inventors: Minhun LEE, Seoul (KR); Soohwan OH, Seoul (KR)

(73) Assignee: LG ELECTRONICS INC., Seoul (KR)

(21) Appl. No.: 14/806,421

(22) Filed: Jul. 22, 2015

Related U.S. Application Data
(60) Provisional application No. 62/027,794, filed on Jul. 23, 2014.

(51) Int. Cl. H04M 1/725

(52) U.S. Cl. CPC H04M 1/7253; H04M 1/7258

(57) ABSTRACT

A method of controlling a mobile terminal, and which includes connecting the mobile terminal to an in-vehicle infotainment (IVI) system of a vehicle through a prescribed protocol; and transmitting a device configuration information related to a service provided by the mobile terminal to the IVI system of the vehicle, wherein the device configuration information includes information on a key button and a UI key button provided by the mobile terminal.

Pursuant to 35 U.S.C. §119(e), this application claims the benefit of earlier filing date and right of priority to U.S. provisional Application No. 62/027,794, filed on Jul. 23, 2014, the contents of which are hereby incorporated by reference herein in their entirety.

### BACKGROUND OF THE INVENTION

1. Field of the Invention

The present invention relates to a method of providing a service of a mobile terminal in an in-vehicle infotainment system, and more particularly, to a method of sharing information on a key button of a mobile terminal efficiently with a vehicle. Although the present invention is suitable for a wide scope of applications, it is particularly suitable for providing the vehicle with a user interface for using the same service of the mobile terminal.

2. Discussion of the Related Art

Recently, as a mobile terminal such as a smartphone is generalized, the demand for using various applications and services provided through the mobile terminal within a vehicle is increasingly rising. Particularly, in providing a service using an application of a mobile terminal among services of an in-vehicle infotainment system (IVI), a connectivity controller (connectivity ECU) is expected as playing a great role.

In order to meet the consumer's needs and to occupy a rapidly developing market of a connectivity controller, vehicle manufacturers make ongoing efforts to research and develop various connectivity controller technologies, IVI system & smartphone interworking technologies (e.g., MirrorLink, Apple Digital iPod Out, Google Android Auto, etc.). According to the connectivity controller technologies, a connection between an IVI system and a mobile terminal is controlled and an environment for sharing applications and services of the mobile terminal is provided by the determined protocol.

Meanwhile, in order for a driver to identically control functions/services provided by a mobile terminal in an IVI system, the physical/software manipulating mechanism unique to the mobile terminal should be provided by the IVI system as well. Moreover, in order to increase usability of services, it is preferable that a user interface (UI) is identically provided to enable the same controls without discrimination between the mobile terminal and the IVI system.

According to an existing IVI & mobile terminal interworking technology, a screen of a mobile terminal is exactly captured and then forwarded to an IVI. Hence, in order to provide a UI for a consistent service control in an IVI system, a negotiation process is required between a mobile terminal and an IVI system. First of all, a supportive main agent for providing a UI as a manipulating mechanism of a mobile terminal is determined. Secondly, an event is mapped to the manipulating mechanism.

However, because the above-mentioned process fails to be clearly defined, a manipulating mechanism is displayed as a UI on every captured frame buffer delivered to the IVI to support a manipulating mechanism (device key) function in providing an application/service to the IVI system from the mobile terminal. Moreover, since the IVI system is unable to know whether the manipulating mechanism (device key) function of the mobile terminal is provided on an application level, the IVI system provides a stand-alone device key UI in order to secure the manipulation.

Such a problem becomes serious because each manufacturer provides a manipulating mechanism of a mobile terminal in a different way. This is described with reference to FIG. 1. In particular, FIG. 1 shows one example of a type of providing a manipulating mechanism to a general smartphone.

Referring to FIG. 1 (a), as various manipulating mechanisms, a touchscreen 110, a key button 120 provided to a lateral surface of a main body, a home key button 130 provided to a front bottom surface of the main body and the like can be provided to a smartphone 100. These manipulating mechanisms may be embodied into software key buttons in part. For instance, referring to FIG. 1 (b), a home key 130′ can be provided as a virtual key button to the touchscreen instead of being embodied into a physical key button. Hence, for the smartphone shown in FIG. 1 (b), despite that a home key is already included in an image provided to an IVI by being captured by the smartphone, a UI corresponding to the home key in the IVI can be redundantly provided. Thus, the non-unified UI causes a problem that usability is lowered.

### SUMMARY OF THE INVENTION

Accordingly, one object of the present invention is to address one or more problems due to limitations and disadvantages of the related art.

Another object of the present invention is to provide a method of sharing information on a key button of a mobile terminal efficiently with a vehicle, by which an efficient manipulating mechanism can be provided in performing an interworking function between a vehicle and a mobile terminal.

To achieve these objects and other advantages and in accordance with the purpose of the invention, as embodied and broadly described herein, a method of transmitting a key button information of a mobile terminal according to one embodiment of the present invention includes connecting to a vehicle through a prescribed protocol and transmitting a device configuration information related to a service provided by the mobile terminal to the vehicle, wherein the device configuration information comprises an information on each of at least one key button provided by the mobile terminal and an information on at least one key button provided with a UI by the mobile terminal.

In another aspect of the present invention, as embodied and broadly described herein, a method of receiving a key button information of a mobile terminal in a vehicle according to another embodiment of the present invention includes connecting to the mobile terminal through a prescribed protocol, receiving device configuration information related to a service provided by the mobile terminal from the mobile terminal, and providing a UI for the service in response to the received device configuration information, wherein the device configuration information comprises an information on each of at least one key button provided by the mobile terminal and an information on at least one key button provided with a UI by the mobile terminal and wherein the UI providing step comprises the step of providing the UI corresponding to at least one portion of the at least one key button provided by the mobile terminal.

Further scope of applicability of the present invention will become apparent from the detailed description given hereinafter. However, the detailed description and specific examples, while indicating preferred embodiments of the invention, are given by illustration only, since various changes and modifications within the spirit and scope of the invention will become apparent to those skilled in the art from this detailed description.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings:

FIG. 1 is a diagram illustrating one example of providing a manipulating mechanism to a general smartphone;

FIG. 2 is a flowchart illustrating a method of performing a screen transmission and a device key event mapping between an IVI system and a smartphone according to one embodiment of the present invention; and

FIG. 3 is a flowchart illustrating a method of performing a negotiation for a screen transmission and a device key event mapping between an IVI system and a smartphone according to one embodiment of the present invention.

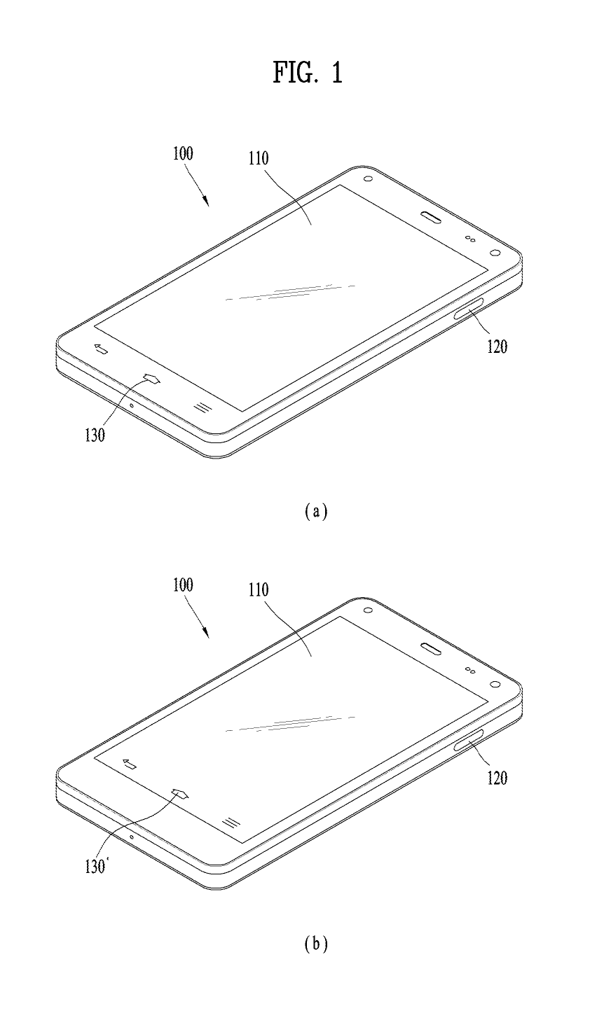

### DETAILED DESCRIPTION OF THE INVENTION

In the following detailed description, reference is made to the accompanying drawing figures which form a part hereof, and which show by way of illustration specific embodiments of the invention. It is to be understood by those of ordinary skill in this technological field that other embodiments may be utilized, and structural, electrical, as well as procedural changes may be made without departing from the scope of the present invention. Wherever possible, the same reference numbers will be used throughout the drawings to refer to the same or similar parts.

A protocol for an interworking between an IVI system and a smartphone, which is mentioned in the present invention, is assumed as following the technology ‘MirrorLink’ as one of the smartphone mirroring technologies provided by the Car Connectivity Consortium. Particularly, according to the general technology ‘MirrorLink’, a client is an IVI system and a server is a smartphone. In addition, such a protocol is exemplarily provided. If a developing tool according to an embodiment of the present invention is a protocol for an interworking function between an IVI system and a smartphone, it is apparent to those skilled in the art that the protocol is applicable to other mobile platforms or connectivity technologies without restrictions.

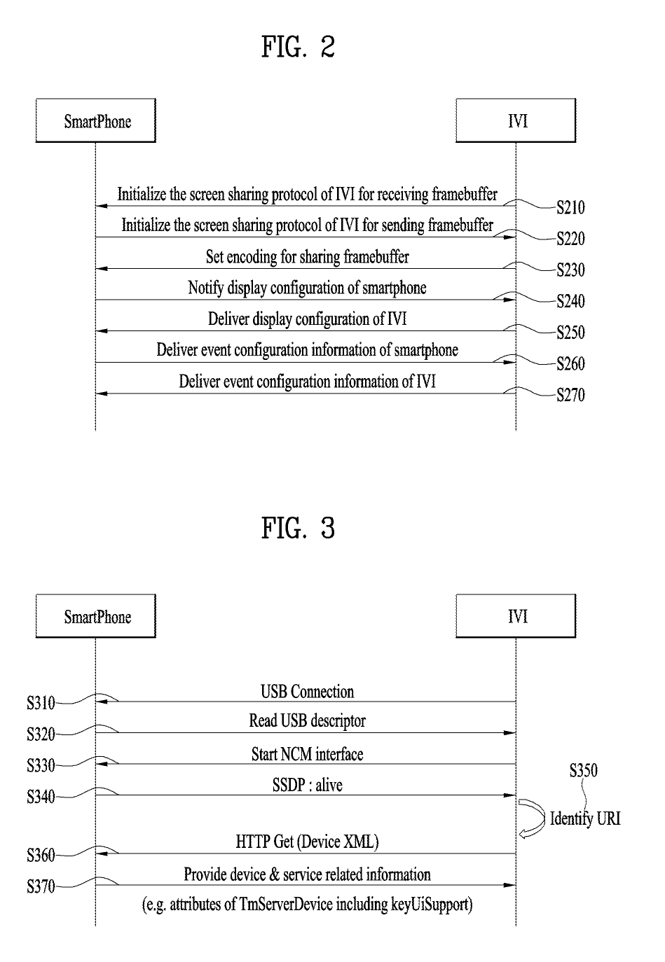

In the following description, an efficient and consistent manipulating mechanism providing method in performing an interworking function between a vehicle and a mobile terminal according to an embodiment of the present invention is described in detail. For clarity of the following description, a mobile terminal includes a smartphone. A preparing procedure for performing an interworking function between an WI system and a smartphone is described in detail with reference to FIG. 2 as follows.

In particular, FIG. 2 is a flowchart illustrating a method of performing a screen transmission and a device key event mapping between an IVI system and a smartphone according to one embodiment of the present invention. Referring to FIG. 2, initialization for transceiving a frame buffer between the smartphone and the IVI system is performed (S210, S220). If the initialization is complete, the IVI system sets an encoding form of the frame buffer in the smartphone (S230). Subsequently, the smartphone and the IVI system exchange display their own configuration information with each other (S240, S250). Moreover, the smartphone and the IVI system exchange event configuration information according to device key manipulations with each other (S260, S270).

In addition, in order to provide physical key and software device key functions of the smartphone as a unified UI in the IVI system for the interworking between the IVI system and the smartphone, it is preferable that a message for determining a main agent for providing a device key function between the IVI and the smartphone is defined. If an element of this message is defined, information is delivered through an HTTP Request based on the defined element and the smartphone and the IVI system can then perform the negotiation for providing the unified UI.

Such a process is described in detail with reference to FIG. 3 as follows. In particular, FIG. 3 is a flowchart illustrating a method of performing a negotiation for a screen transmission and a device key event mapping between the IVI system and the smartphone according to one embodiment of the present invention.

Referring to FIG. 3, the smartphone is connected to the IVI system through a USB connection (S310). Hence, the IVI system reads a USB descriptor of the smartphone (S320). In the USB descriptor, a class information of a mobile terminal, an information on a presence or non-presence of support of NCM (network control model) and the like are included. If the smartphone supports NCM in the step S320, the IVI system checks whether the smartphone is ready for a socket communication (S340). If the smartphone is ready for the socket communication, the IVI system identifies a URI (uniform resource identifier) (S350) and then makes a request for device & service related information of the smartphone (S360). In response to the request, the smartphone transmits the device & service related information to the IVI system (S370). Further, information for providing a device key UI according to an embodiment of the present invention can be included in the device & service related information.

Configuration of the device & service related information according to an embodiment of the present invention is described in detail as follows. First of all, device information and configuration information related to a service of a smartphone preferably include information that can be discovered and accessed by a UPnP Control Point of the IVI system. Hence, one embodiment uses TmServerDevice as device & service related information in which information for providing the device key UI can be included. The TmServerDevice information may be urn:schemas-upnp-org:device:TmServerDevice:TmServerDevice (i.e., TmServerDevice message) of the UPnP root device defined based on the UPnP spec or embedded within a different device.

Table 1 shows one example that information for providing a device key UI according to one embodiment of the present invention is configured with extended attributes of TmServerDevice information.

TABLE 1

| | | | Avail- |
|---|---|---|---|
| Element | Description | Parent | ability |
| X_deviceKeys | Defines device specific | device | Optional |
| | physical hard keys which | | |
| | MAY be replicated on | | |
| | the client side | | |
| key | Defines a device specific | X_deviceKeys | Optional |
| | key | | |
| Name | Short name of the key; to | key | Mandatory |
| | be used, if icon is not | | |
| | available or shown | | |
| | (A_ARG_TYPE_String) | | |
| mandatory | Flag, whether the key is | key | Optional |
| | mandatory to ensure | | |
| | minimum functionality | | |
| | of the device | | |
| | Deprecated; MirrorLink | | |
| | Client MUST use | | |
| | default value. | | |
| | (A_ARG_TYPE_Bool) | | |
| | Default: false | | |
| symbolValue | Key's symbol hexadecimal | key | Mandatory |
| | value (A UTF-8 encoded | | |
| | string representing an | | |
| | unsigned 32-bit integer in | | |
| | hexadecimal format (with | | |
| | ‘0x’ prefix).) | | |
| keyUiSupport | Boolean flag to indicate | key | Mandatory |
| | whether MirrorLink Server | | |
| | device supports UI of | | |
| | a device specific key | | |
| | (A_ARG_TYPE_Bool) | | |
| | Default: false | | |
| icon | Describes an icon | key | Optional |
| | representing the key | | |

Referring to Table 1, in X_deviceKeys element, physical hard keys replicable in the IVI system can be defined through key element and its subordinate elements. In this instance, to avoid displaying redundant UI for Keys listed in the X_deviceKeys, it is preferable that a smartphone (MirrorLink Server) indicates whether it provides UI of a device specific key. Thus, keyUiSupport element among the subordinate elements of the key element like Table 1 enables ‘whether the MirrorLink server, i.e., the smartphone supports the UI of the device specific key at any time’ to be represented as a flag. In this instance, the IVI (i.e., MirrorLink Client) MUST NOT provide UI of a device specific key if the smartphone indicates to support UI of a device specific key.

In Table 1, keyUiSupport element is included as a subordinate element of the key element and embodied to indicate whether MirrorLink Server provides a UI per key. Yet, the keyUiSupport element can be configured at a location other than the subordinate element of the key element as a list of device specific keys which are supported from the MirrorLink Server in its provided user interface. Similar to the symbolValue element shown in Table 1, corresponding key buttons can be included as corresponding symbol value forms (e.g., hexadecimal numbers) in the list.

In this instance, the present element can be included as the subordinate element of the device element in Table 1, and the MirrorLink Client MUST NOT provide a dedicated soft-button of all device specific keys included in the list. Further, by additionally adding keyUiSupport element and separate element, it can explicitly indicate a device specific key to which MirrorLink Server must not provide a UI irrespective of whether the UI of smartphone is provided. In this instance, the IVI system may not provide a UI for a device specific key indicated by the corresponding separate element only.

Meanwhile, in Table 1, the key or icon element can have multiple instances. Moreover, such a name of the element as keyUiSupport or the like is exemplary only. In addition, a name of element can be changed into another corresponding name such as X_server DeviceKeys or the like.

‘keytUiSupport Element’ defined in Table 1 may be used in form such as Table 2.

Table 2 shows one example of a type for determining a main agent for applying UI according to one embodiment of the present invention.

TABLE 2

| | Driving regulation applied - | Driving regulation not-applied - |
|---|---|---|
| | Head Unit | Rear Seat Entertainment |
| Element Value | keyUiSupport == true | keyUiSupport == false |
| | <key> | <key> |
| | <name>Home</name> | <name>Home</name> |
| | <mandatory>true</mandatory> | <mandatory>false</mandatory> |
| TmServerDevice | <symbolValue>0x3000020D</symbol | <symbolValue>0x3000020D</symbol |
| example | Value> | Value> |
| | <keyUiSupport>true</keyUiSupport> | <keyUiSupport>true</keyUiSupport> |
| | [. . .] | [. . .] |
| | </key> | </key> |

Referring to Table 2, if a driving regulation is applied to a head unit such as a display of an IVI system, a smartphone supports a device key by software on an application level. An IVI system does not apply a key list information delivered from the smartphone to a native UI. On the contrary, when a driving regulation is not applied such as a display for a rear seat user, a smartphone does not support a device key by software. An IVI system applies a key list information delivered from the smartphone to a native UI.

Moreover, technologies other than MirrorLink can perform a device key related negotiation in order to define a message ‘keyUiSupport’ like Table 3 and to provide a device key function required for the interworking between a smartphone and an IVI system through HTTP communication, An operation varying in accordance with a value of Message is identical to that shown in Table 2.

Meanwhile, according to the smartphone interworking technology other than MirrorLink, a message shown in Table 3 can be defined for negotiation in providing a device key function.

TABLE 3

| Message | Description | Type | Availability |
|---|---|---|---|
| keyUiSupport | Boolean flag to indicate | Boolean | Required |
| | whether MirrorLink Server | Default: | |
| | device supports UI of | false | |
| | a device specific key | | |

Of course, as mentioned in the foregoing description with reference to Table 1, the keyUiSupport element can be represented not as a flag but as a list.

As mentioned in the foregoing description, in order to provide a device key function required for interworking between the IVI system and the smartphone as a unified UI in aspect of a user, according to an embodiment of the present invention, a method of defining a device key UI related element in attribute of TmServerDevice is provided. Through this, a main agent for UI configuration of a specialized device key of the smartphone device required for using an interworking technology between the ITV system and the smartphone can be efficiently coordinated between the IVI and the smartphone. Moreover, when the IVI system and the smart device interwork with each other, high compatibility can be secured and a user can be provided with a unified UI with high usability.

Further, the mobile terminal and IVI includes a controller such as a hardware-embedded processing chip executing the described algorithms for performing the described function.

Accordingly, the present invention provides the following advantages. First of all, a manipulating mechanism of a mobile terminal can be efficiently provided through an IVI system in performing an interworking function between an IVI and a mobile terminal. Particularly, according to an embodiment of the present invention, since a key button of a mobile terminal, which will not be provided as a UI, is specified in a negotiation process between the mobile terminal and an IVI system, a manipulating mechanism of the mobile terminal can be consistently provided in the IVI system.

It will be apparent to those skilled in the art that various modifications and variations can be made in the present invention without departing from the spirit or scope of the inventions. Thus, it is intended that the present invention covers the modifications and variations of this invention provided they come within the scope of the appended claims and their equivalents.

What is claimed is:

1. A method of controlling a mobile terminal, the method comprising:
connecting the mobile terminal to an in-vehicle infotainment (IVI) system of a vehicle through a prescribed protocol; and
transmitting a device configuration information related to a service provided by the mobile terminal to the IVI system of the vehicle,
wherein the device configuration information includes information on a key button and a UI key button provided by the mobile terminal.

2. The method of claim 1, wherein the information on the UI key button includes a list of UI key buttons provided by the mobile terminal.

3. The method of claim 1, wherein the information on the UI key button includes an element indicating whether a corresponding UI key button should be provided on the IVI of the vehicle, as a subordinate information of the information on the key button and the UI key button.

4. The method of claim 3, wherein the element indicating Whether the corresponding UI key button is provided has a value set as a flag.

5. The method of claim 1, wherein the IVI system of the vehicle is connected to the mobile terminal through a USB connection, and
wherein the prescribed protocol comprises MirrorLink technology protocol.

6. The method of claim 5, wherein the device configuration information comprises TmServerDevice.

7. The method of claim 1, wherein the IVI does not provide an additional corresponding UI key button for the UI key button included in the information received from the mobile terminal.

8. A method of controlling an in-vehicle infotainment (IVI) system of a vehicle the method comprising:
connecting the system to a mobile terminal through a prescribed protocol;
receiving device configuration information related to a service provided by the mobile terminal from the mobile terminal; and
providing a UI for the service to the mobile terminal in response to the received device configuration information,
wherein the device configuration information includes information on a key button and a UI key button provided by the mobile terminal.

9. The method of claim 8, wherein the information on the UI key button includes a list of UI key buttons provided with the UI.

10. The method of claim 8, wherein the information on the UI key button includes an element indicating whether a corresponding UI key button should be provided on the IVI of the vehicle, as a subordinate information of the information on the key button and the UI key button.

11. The method of claim 10, wherein the element indicating whether the corresponding UI key button is provided has a value set as a flag.

12. The method of claim 8, wherein the IVI system of the vehicle is connected to the mobile terminal through a USB connection, and
wherein the prescribed protocol comprises MirrorLink technology protocol.

13. The method of claim 12, wherein the device configuration information comprises TmServerDevice.

14. The method of claim 8, wherein the IVI does not provide a corresponding UI key button included in the information received from the mobile terminal.

15. A mobile terminal, comprising:
a USB connection configured to connect the mobile terminal to an in-vehicle infotainment (IVI) system of a vehicle through a prescribed protocol; and
a controller configured to transmit a device configuration information related to a service provided by the mobile terminal to the IVI system of the vehicle,
wherein the device configuration information includes information on a key button and a UI key button provided by the mobile terminal.

16. The mobile terminal of claim 15, wherein the information on the UI key button includes a list of UI key buttons provided by the mobile terminal.

17. The mobile terminal of claim 15, wherein the information on the UI key button includes an element indicating whether a corresponding UI key button should be provided on the IVI of the vehicle, as a subordinate information of the information on the key button and the UI key button.

18. The mobile terminal of claim 17, wherein the element indicating whether the corresponding UI key button is provided has a value set as a flag.

19. The mobile terminal of claim 15, wherein the IVI system of the vehicle is connected to the mobile terminal through a USB connection, and
wherein the prescribed protocol comprises MirrorLink technology protocol.

20. The mobile terminal of claim 19, wherein the device configuration information comprises TmServerDevice.
